(19) United States
(12) Patent Application Publication
(10) Pub. No.: US 2016/0104095 A1
(43) Pub. Date: Apr. 14, 2016

(54) SYSTEMS AND COMPUTER-IMPLEMENTED METHODS OF AUTOMATED ASSESSMENT OF PERFORMANCE MONITORING ACTIVITIES

(71) Applicant: PeopleStreme Pty Ltd, Melbourne (AU)

(72) Inventors: Lyle POTGIETER, Mount Eliza (AU); Dale SMALLEY, Tweed Heads (AU); Claire RASMANIS, Bacchus Marsh (AU)

(21) Appl. No.: 14/510,898

(22) Filed: Oct. 9, 2014

(51) Int. Cl. G06Q 10/06

(52) U.S. Cl. CPC G06Q 10/06398

(57) ABSTRACT

A system for automatic assessment of performance monitoring activities. the system comprises an interface for receiving commands to perform the automatic assessment of performance monitoring activities, memory comprising an executable assessment application and at least one processor configured to access and execute the assessment application to automatically assess performance monitoring activities in response to receiving a command from the interface. The assessment application comprises an assessment module for obtaining a performance record associated with an employee, wherein the performance record comprises at least one performance objective and a parsing module for parsing the performance report to determine whether each objective includes assessment criteria, wherein the assessment criteria comprises a hard verb, a quantity measure, a time measure and a quality measure and for determining a first parsed result, the first parsed result being based on the determination of whether each objective includes assessment criteria, and wherein the assessment module is configured to determine a first assessment result based on the first parsed result.

### FIELD

Described embodiments relate to systems and computer-implemented methods of automated assessment of performance monitoring activities, and in particular, systems and computer-implemented methods for automatically assessing performance records, such as performance objective reports, performance review reports and meetings data.

### BACKGROUND

In the past, businesses and organisations have tended to be assessed with reference to their financial performance, without due concern to factors such as job satisfaction and employee engagement. However, recent research suggests that many business and companies actually derive a greater proportion of their value from non-tangible assets such as branding and employees than from tangible assets such as machinery and property. This suggests that employee satisfaction and engagement with their work should be an important factor for companies to consider.

Accordingly, some companies and businesses employ performance management systems to assess and monitor employee satisfaction and engagement. Such systems rely on the ability of managers and employees to effectively communicate with one another to set clear objectives and targets so that the employee may continue to develop professionally. However, ambiguous objectives and targets, misunderstandings, and/or lack of communication between managers and employees can be frustrating and demotivating for the employee and may negate any benefit derived from such performance management systems.

It is desired to address or ameliorate one or more shortcomings or disadvantages associated with prior performance management methods and systems or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiment relate to a system for automatic assessment of performance monitoring activities, the system comprising an interface for receiving commands to perform the automatic assessment of performance monitoring activities, memory comprising an executable assessment application and at least one processor configured to access and execute the assessment application to automatically assess performance monitoring activities in response to receiving a command from the interface, the assessment application comprising an assessment module for obtaining a performance record associated with an employee, wherein the performance record comprises at least one performance objective and a parsing module for parsing the performance report to determine whether each objective includes assessment criteria, wherein the assessment criteria comprises a hard verb, a quantity measure, a time measure and a quality measure and for determining a first parsed result, the first parsed result being based on the determination of whether each objective includes assessment criteria, wherein the assessment module is configured to determine a first assessment result based on the first parsed result.

In some embodiments, the interface may be a user interface and the user interface may be configured to receive the command to automatically assess performance monitoring activities from a user. The assessment module may be configured to provide the assessment result to the user interface for outputting to the user. In some embodiments, the system may further comprise a communications interface to facilitate wired or wireless communications and wherein the assessment module may be configured to provide the assessment result to the communications interface for transmitting to a computing device or database.

In some embodiments, the interface may be a communications interface to facilitate wired or wireless communications and may be configured to receive the command to automatically assess performance monitoring activities from a remote computing device. The assessment module may be configured to provide the assessment result to the communications interface for transmitting to a computing device or database. In some embodiments, the system may further comprise a user interface and the assessment module may be configured to provide the assessment result to the user interface for outputting to a user.

In some embodiments, the system may further comprise data storage for storing data pertaining to the assessment application. The assessment module may be configured to obtain the performance record and/or the assessment criteria from the data storage. In some embodiments, the assessment module may be configured to obtain the performance record and/or the assessment criteria from remote data storage using the communications interface.

In some embodiments, the at least one performance record may comprise at least one of a performance objective report, a performance review report and meeting data.

In some embodiments, the hard verb may be associated with an active change which is proposed to be achieved, the quantity measure may be a proposed level of increase or decrease of active change, the time measure may be a time frame during which the active change is proposed to be achieved and the quality measure may be a constraint applied in order to achieve the active change.

In some embodiments, the assessment module may be configured to access a parsing lexicon comprising a list of terms associated with each assessment criterion and the parsing module may be configured to parse the performance record by comparing the performance record with the terms of the parsing lexicon to determine whether the performance record includes at least one of the terms. The first parsed result may comprise an indication of a number of performance objectives which include each of the assessment criteria.

In some embodiments, the assessment module may be further configured to determine a total number of objectives in the performance record and wherein the assessment result may also depend on the on the total number of objectives in the performance record.

In some embodiments, the assessment module may be further configured to determine a total number of short objectives in the performance record and wherein the assessment result also depends on the number of short objectives in the performance record.

In some embodiments, the performance report may further comprise a performance review record and wherein the parsing module may be configured to parse the performance record to determine a second parsed result based on at least one of a number of employee comments associated with an employee and a number of comments associated with a manger of the employee and the assessment module may be configured to determine a second assessment result based on the second parsed result. The assessment module may be configured to determine an overall assessment result based on the first and second assessment results.

In some embodiments, the performance report may further comprise a meeting data record and wherein the parsing module may be configured to parse the performance record to determine a third parsed result based on an occurrence of meetings between an employee and their manager and the assessment module may be configured to determine a third assessment result based on the third parsed result. The assessment module may be configured to determine an overall assessment result based on at least one of the first, second and third assessment results.

In some embodiments, the assessment module may be configured to obtain configuration settings and to apply the configuration settings to the assessment result to determine a weighted assessment result.

Some embodiments relate to a system for automatic assessment of performance monitoring activities, the system comprising an interface for receiving commands to perform the automatic assessment of performance monitoring activities, memory comprising an executable assessment application and at least one processor configured to access and execute the assessment application to automatically assess performance monitoring activities in response to receiving a command from the interface, the assessment application comprising an assessment module for obtaining a performance record associated with an employee, wherein the performance record comprises at least one performance review report and a parsing module for parsing the performance report to determine a parsed result based on at least one of a number of employee comments associated with an employee and a number of comments associated with a manger of the employee and wherein the assessment module is configured to determine an assessment result based on the first parsed result.

In some embodiments, the performance report may further comprise a meeting data record and wherein the parsing module may be configured to parse the performance record to determine a second parsed result based on an occurrence of meetings between an employee and their manager and the assessment module may be configured to determine a second assessment result based on the second parsed result.

In some embodiments, the assessment module may be configured to determine an overall assessment result based on at least one of the first and second assessment results.

Some embodiments relate to a computer implemented method of assessing performance monitoring activities, the method operable in a computing system comprising an interface for receiving commands to perform the automatic assessment of performance monitoring activities, memory comprising an executable assessment application and at least one processor configured to access and execute the assessment application to automatically assess performance monitoring activities in response to receiving a command from the interface, the method comprising obtaining by an assessment module of the assessment application a performance record associated with an employee, wherein the performance record comprises at least one performance objective, parsing by a parsing module of the assessment application, the performance report to determine whether each objective includes assessment criteria, wherein the assessment criteria comprises a hard verb, a quantity measure, a time measure and a quality measure, determining by a parsing module a parsed result, the parsed result being based on the determination of whether each objective includes assessment criteria and determining by the assessment module a first assessment result based on the parsed result.

In some embodiments, the method may further comprise determining at least one of a total number of objectives in the performance record and a number of short objectives in the performance record, and wherein the first assessment result may be further based on at least one of the total number of objectives and number of short objectives.

In some embodiments, the performance report may further comprise a performance review record and the method may further comprise parsing by the parsing module the performance record to determine a second parsed result based on at least one of a number of employee comments associated with an employee and a number of comments associated with a manger of the employee and determining by the assessment module a second assessment result based on the second parsed result.

In some embodiments, the method may further comprise determining an overall assessment result based on at least one of the first and second assessment results.

In some embodiments, the performance report may further comprise a meeting data record and the method may further comprise parsing by the parsing module the performance record to determine a third parsed result based on an occurrence of meetings between an employee and their manager and determining by the assessment module a third assessment result based on the third parsed result.

Some embodiments relate to a computer program product comprising a non-transitory computer readable medium encoded with computer executable instructions, which when executed in a computer system, is effective to cause the computer system to carry out the steps of the described method.

### BRIEF DESCRIPTION OF THE DRAWINGS

Examples are described in further detail below, with reference to the drawings, in which:

FIG. 1 is a block diagram representation of a computing device configured to perform a computer-implemented method of assessing performance monitoring activities according to some embodiments;

FIG. 2 is a block diagram representation of an application and data storage provided in a memory of the computing device of FIG. 1, the application being executable by the computing device to perform a computer-implemented method of assessing performance monitoring activities according to some embodiments;

FIG. 3 is a flowchart showing a computer-implemented method for assessing employee objectives which may be performed by the application of FIG. 2;

FIG. 4 is a flowchart showing a computer-implemented method for assessing performance review reports which may be performed by the application of FIG. 2;

FIG. 5 is an example screenshot of an objective review feature of the application of FIG. 2;

FIG. 6 is an example screenshot of a performance objective review feature of the application of FIG. 2; and

FIG. 7 is an example screenshot of a scoring feature of the application of FIG. 2.

### DETAILED DESCRIPTION

Described embodiments relate to systems and computer-implemented methods of automated assessment of performance monitoring activities, and in particular, systems and methods of automatically assessing performance records, such as performance objective reports, performance review reports and meetings data.

Some embodiments relate to systems and computer-implemented methods for automatically assessing performance monitoring activities of employees within a company or organisation. For example, performance monitoring activities may include setting of performance objectives or tasks for or by employees, performance reviews being held to monitor the employee's progress, and meetings being held between employees and their supervisors and/or managers. In some embodiments, the automatic assessment of the performance monitoring activities may be an assessment of at least one performance record associated with an employee and may comprise causing a processor to execute program code to parse the at least one performance record to determine whether or not the record complies with a set of criteria. For example, the performance record may comprise a performance objective report, a performance review report and/or meeting data associated with an employee.

In some embodiments, the automatic assessment may include the determination of a preliminary assessment result for each type of performance monitoring activity, for example to determine a quality or effectiveness of the performance monitoring activities. In some embodiments, the automatic assessment may include the determination of an overall assessment result based on one or more preliminary assessment results. For example, weightings may be applied to the preliminary assessment results before the overall result is calculated, to reflect the relative importance of each performance monitoring activity. The weightings may be adjustable.

The results of the assessment of the performance monitoring activities may be stored at a database, local or remote to the system and may be accessible to another computing system via a wired or wireless communications network. In this way, comparisons of assessment results can be made company wide, even when portions of the company are remote from one another.

The described systems and computer-implemented methods provide for efficient processing of large amounts of data to determine a measure of the effectiveness of performance monitoring activities. such as whether useful objectives are being set, sufficient feedback is being given at performance reviews, and whether meetings are being held often enough. Assessments can be performed in a discrete, anonymous and unbiased way and a single standard of assessment can be applied, regardless of the geographical spread of the organisation. Furthermore, the assessment of the performance monitoring activities enables the effectiveness of managers and managerial strategies to be assessed and monitored over time and across an organisation.

In the following specification, the term company will be used generically and will be considered to include both corporate and non-corporate entities, governmental and semi-governmental authorities and other organisations. In the following specification, while the terms employee, company and manager will be used, the described systems, methods and computer program products may be applied to any organisation, club or group, and can be applied to any participants, members, volunteers or leaders.

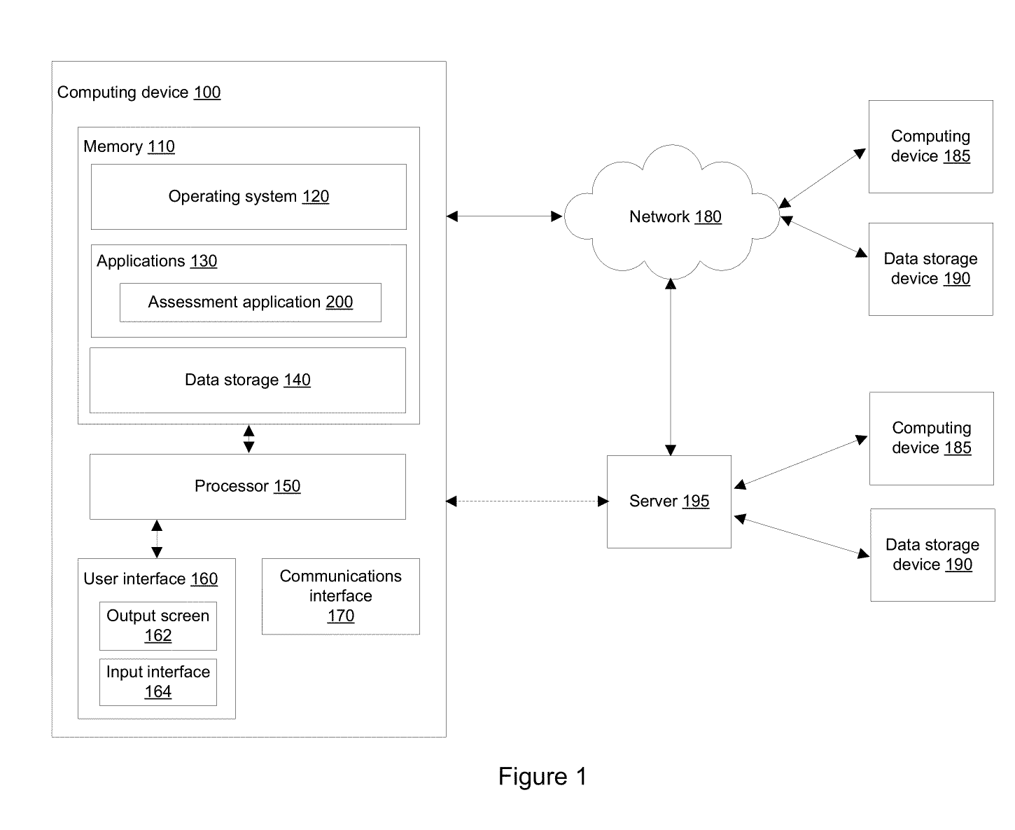

FIG. 1 is a block diagram of a computing device 100 which may be configured to perform a computer-implemented method for automatically assessing performance monitoring activities. Computing device 100 has memory 110, a processor 150, user interface 160 and communications interface 170. In some embodiments, computing device 100 may comprise a smartphone, tablet, laptop, PC, server or server system. Computing device 100 may in some embodiments be or comprise a computing system, having multiple computing devices, servers or server systems.

Memory 110 is accessible by processor 150 to store and retrieve data. Memory 110 may include read-only memory (ROM) such as erasable ROM (EROM) and electrically erasable programmable ROM (EEPROM or flash ROM), or random access memory (RAM) such as static RAM (SRAM), dynamic RAM (DRAM) or non-volatile RAM (NVRAM or flash). Memory 110 includes an operating system 120, applications 130, and data storage 140. Applications 130 include an assessment application 200, according to some embodiments.

Processor 150 may include a microprocessor or a microcontroller, and in some embodiments, processor 150 may include multiple processors, and may also or instead include components such as digital signal processing units (DSPUs), central processing units (CPUs), arithmetic logic units (ALUs) and registers for storing data. Processor 150 is configured to execute instructions from memory 110 to perform functions associated with described embodiments. For example, assessment application 200 may be executed by processor 140 in order to perform a method of automatic assessing performance monitoring activities.

User interface 160 may include an electronic visual display such as an output screen 162 to output data to a user, and an input interface 164 to receive data from the user. In some embodiments, output screen 162 may include a touchscreen, and input interface 164 may include a touch screen digitiser. In some embodiments, input interface 164 may include input peripherals such as push buttons, switches, keyboards, electronic mice, microphones and cameras User interface 160 may further include output peripherals such as lights, LEDs, motors and speakers.

Communications interface 170 may comprise components configured to allow for wired or wireless communication between computing device 100 and other external or remote devices (not shown). For example, communications interface 170 may comprise a USB port, Ethernet port, a wireless adapter or a Bluetooth module. Communications interface 170 may be configured to allow computing device 100 to communicate with external devices over the mobile network, the Internet, or other communications networks.

Computing device 100 may be in communication with one or more external computing devices 185, one or more external data storage devices 190 and one or more servers 195 or server systems, either through a communications network 180 or directly. Network 180 may be the Internet, in some embodiments.

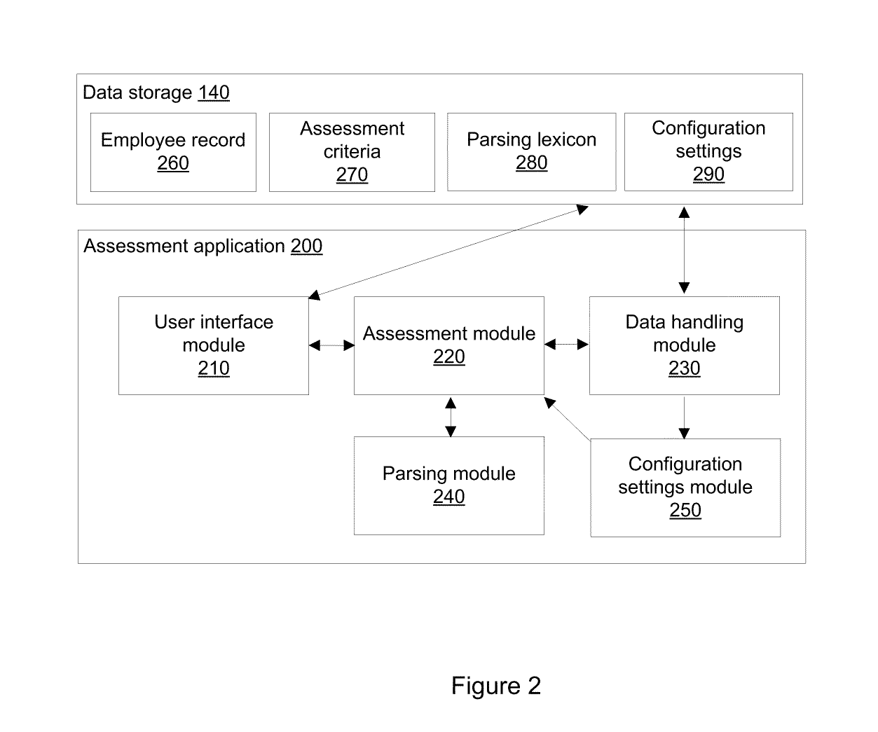

FIG. 2 shows assessment application 200 in more detail. Assessment application 200 is made up of code modules, such as user interface module 210, assessment module 220, data handling module 230, parsing module 240 and configuration settings module 250. Each code module 210, 220, 230, 240 and/or 250 comprises program code or instructions executable by processor 150 to perform methods of automatically assessing performance monitoring activities according to some embodiments. For example, assessment application 200 may be used by employees and/or their managers to record and automatically assess performance monitoring activities such as objectives, reports, performance reviews, and/or meetings, such as one-to-one meetings.

User interface module 210 may comprise code, which when executed by processor 150 causes data to be received from and provided to user interface 160. In particular, user interface module 210 may be configured to instruct processor 150 to cause a user interface display (not shown) to be shown on output screen 162, and to receive input via input interface 164 as to how the user interacts with the display. Users of assessment application 200 may be able to save data to and/or retrieve data from data storage 140, or other local or remote data storage locations via wired or wireless communication.

In some embodiments, an employee record 260 may be created for each employee to be monitored. The employee record 260 may be stored in data storage 140 or at a remote database (not shown). The employee record 260 may comprise data such as account information for each employee and manager and information relating to performance monitoring activities. For example, information relating to performance monitoring activities may comprise performance records including at least one of performance objective reports, performance review reports and/or meeting data.

In some embodiments, processor 150 may execute code to cause the employee record 260 to be created, modified and/or deleted in response to instructions received from user interface module 210 and/or instructions received from a remote computing device (not shown).

In some embodiments, data storage 140 further stores assessment criteria 270, a parsing lexicon 280 and configuration settings 290. In some other embodiments, assessment criteria 270, a parsing lexicon 280 and/or configuration settings 290 may be stored at a remote database (not shown).

In some embodiments, assessment criteria 270 may comprise objectives criteria such as short objectives criteria, verb criteria, quantity criteria, quality criteria and time criteria and performance review criteria such as short employee comment criteria and short manager comment criteria.

Parsing lexicon 280 may contain an editable and updatable database of words, terms, and/or linguistic patterns used to determine whether a performance record meets a particular criterion. In some embodiments, parsing lexicon 280 may be divided into several databases, with each database being associated with one criterion, such as a verb criterion or a quality criterion. A user may be able to add or update entries in parsing lexicon 280.

Configuration settings 290 may store weightings and scoring protocol data for determining a result for the performance monitoring activities that have been assessed based on assessment criteria 270.

In some embodiments, assessment criteria 270, parsing lexicon 280 and configuration settings 290 may be created, modified, and/or deleted by a user via interaction with user interface 160. For example, in response to an input received via user interface 160, processor 150 may execute code stored in the operating system 120 to create, modify and/or delete data associated with assessment criteria 270, parsing lexicon 280 and configuration settings 290.

Based on commands from a user, user interface module 210 may be configured to communicate with assessment module 220 to automatically initiate an assessment of performance monitoring activities associated with an employee and stored in employee record 260 based on assessment criteria 290. For example, in response to an input received via user interface 160, processor 150 may execute program code to cause the user interface module 210 to communicate with the assessment module 220 and cause the assessment module 220 to initiate an assessment of performance monitoring activities associated with an employee record. Assessment module 220 may be configured to retrieve assessment criteria 270 in order to perform the assessment. The assessment may comprise an assessment of data pertaining to one or more performance monitoring activities associated with or linked to one or more employee accounts. In some embodiments, the assessment may be an assessment of at least one performance record of an employee record 260. For example, the assessment may comprise an assessment of a performance objective report, a performance review report and/or meeting data associated with an employee.

Assessment module 220 may communicate with data handling module 230 to access data, such as performance record(s) of employee records(s) 160 from data storage 140, or from an external database or storage device. For example, processor 150 may execute program code to cause assessment module 220 to communicate with data handling module 230 and cause data handling module 230 access data and to provide the data to assessment module 220.

Assessment module 220 may be configured to assess performance records pertaining to a performance monitoring activity associated with an employee passed to assessment module 220 from data handling module 230 and to automatically determine an assessment of the activities for the employee. For example, the assessment may include a numerical score-based assessment in some embodiments.

Assessment module may pass data from employee record 260 to parsing module 240, which may assess whether or not the performance records from employee record 260 meet assessment criteria 270, and/or an extent of compliance with assessment criteria 270. For example, processor 150 may execute program code to cause assessment module 220 to pass data from employee record 260 to parsing module 240 and cause parsing module 240 to parse the data and return a parsed result to the assessment module 220. In some embodiments, parsing module 240 may parse each data record for words or word patterns in order to determine a result for each criterion. For example, parsing module 240 may parse the performance records by comparing data of the performance record with a list of pre-defined terms stored in parsing lexicon 280 to identify the presence or absence of those terms in the performance record. Parsing module 240 automatically communicates a parsed result to assessment module 220.

Assessment module 220 may communicate with data handling module 230 to retrieve configuration settings 290 from data storage 140 and/or from a remote database (not shown) and pass configuration settings 290 to configuration settings module 250. For example, processor 150 may execute program code to cause assessment module 220 to communicate with data handling module 230 and cause data handling module 230 to access configuration settings 290 and to provide configuration settings 290 to configuration settings module 250. Configuration settings module 250 may use configuration settings 290 to determine weightings to be applied to the parsed results received from parsing module 240. These weightings may then be communicated to assessment module 220. For example, processor 150 may execute program code to cause configuration settings module 250 to determine the weightings and provide the weightings to assessment module 220.

Assessment module 220 may use data, such as the parsed results received from parsing module 220 and the weightings received from configurations module 250, to determine an overall assessment result for a particular performance record associated with an employee record 260. Each assessment result may relate to an individual employee performance monitoring activity, such as a performance objective report, performance review or meeting.

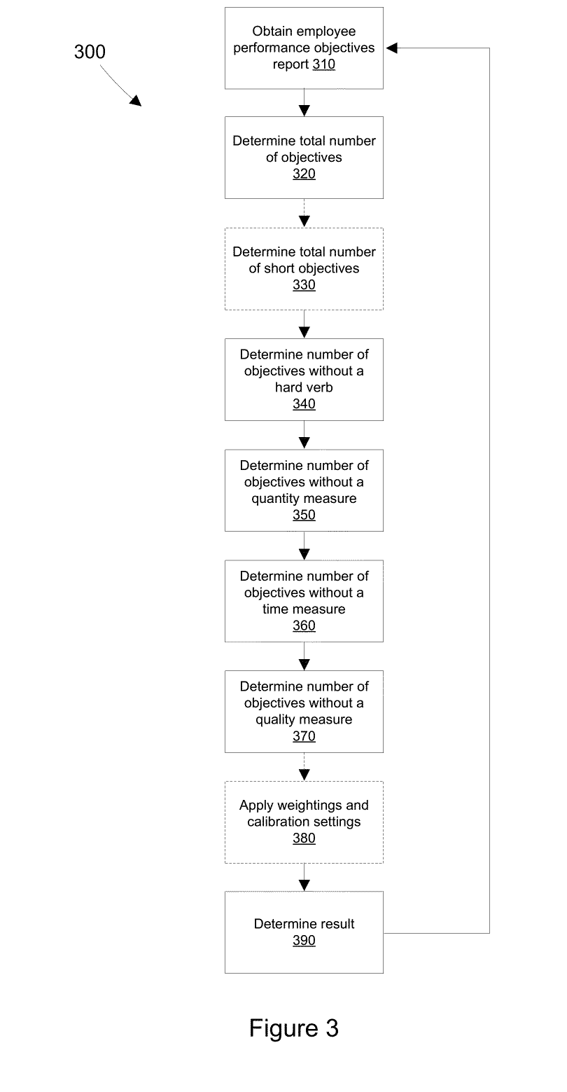

FIG. 3 shows a computer-implemented method 300 which may be implemented by application 200, when executed by processor 150, in order to perform an automatic assessment of a performance objectives report associated with an employee based on assessment criteria 270. In the illustrated embodiment, assessment criteria 270 includes a total number of objectives, a number of short objectives, a number of objectives without a hard verb, a number of objectives without a quantity measure, a number of objectives without a time measure, and a number of objectives without a quality measure.

At step 310, assessment module 220 obtains a performance objectives report associated with an employee and comprising at least one performance objective. The report may be retrieved from an employee record 260 stored in data storage 140 or an external data storage means via communications interface 170 by data handling module 230, or may be retrieved directly from user interface 160 through user interface module 210 in some embodiments.

The objectives report may comprise one or more objectives. For example, objectives may be entered in sentence format, such as “I will increase profits by 20% by the end of the year, without decreasing product quality”, or an objective creating tool may be employed to assist the employee to create objectives. In some embodiments, a performance report may comprise a plurality of objectives, each objective representing a discrete item of the performance objective report.

A user, such as an employee and/or manager, may create a performance objectives report and add objectives to the performance objectives report or modify the objectives of the performance objectives report using assessment application 200 or another application, on a periodic basis, or as required from time to time. The performance objectives and/or performance objectives report may be uploaded directly to the performance record of the employee record 160 at data storage 140 or another data storage means. Alternatively, an employee may create a performance objectives report and/or add or modify performance objectives externally to assessment application 200, and the performance objectives and/or performance objectives report may be uploaded at a later stage.

At 320, assessment module 220 automatically determines a total number of objectives entered by the user. Alternatively, the method may move directly to step 330 or step 340. Assessment module 220 may pass a total number of objectives to data handling module 230 to be stored in data storage 140.

At 330, assessment module 220 may, in some embodiments, automatically determine a total number of short objectives entered by the employee. An objective may be determined to be a short objective if it does not meet a length requirement in either characters, words, or both. Assessment module 220 may pass the total number of short objectives to data handling module 230 to be stored in data storage 140. Alternatively, the method may move directly to step 340

At 340, assessment module 220 automatically determines a number of performance objectives with or without a hard verb. The “hard verb” term refers to an extent to which an objective includes an active action which the employee is required to complete to produce a desired result. Some examples of objectives which may satisfy the verb criteria may include increasing a particular output, saving an amount of time or material, or increasing the level of quality control.

As part of 340, assessment module 220 passes each objective to parsing module 250. Parsing module 250 parses each objective for hard verbs that indicate an action (as opposed to soft verbs such as “try” or “attempt”), based on data retrieved from parsing lexicon 280, and then automatically returns a result to assessment module 220 indicating whether or not the given objective meets the criteria. Some examples of terms that may indicate that the verb criteria is being met, being terms that may be stored in parsing lexicon 280 and terms that parsing module 240 may parse for, may include but are not limited to:

### Accelerate

### Achieve

### Acquired

### Action

### Address

### Administer

### Agree Allocate

### Analyse

### Answer

### Apply

### Broaden

### Budget

### Build

### Change

### Check

### Clean

### Clear

At 350, assessment module 220 automatically determines a number of employee objectives without a quantity measure. The “quantity measure” term refers to whether the objective specifies the amount by which the action satisfied by the verb criteria should increase or decrease a particular measurable outcome. For example, if the objective is to increase production, then the quantity criteria require that the objective also indicates the percentage change or absolute change required in the production.

As part of 350, assessment module 220 passes each objective to parsing module 250. Parsing module 250 parses each objective for quantity measures, based on data retrieved from parsing lexicon 280, and then automatically returns a result to assessment module 220 indicating whether or not the given objective meets the criteria. Assessment module 220 keeps a tally of the number of objectives without quantity measures, and may pass the number to data handling module 230 to be stored in data storage 140. Some examples of terms that may indicate that the quantity criteria is being met, being terms that may be stored in parsing lexicon 280 and terms that parsing module 240 may parse for, may include but are not limited to:

### $xx of Service x

$xxx of product x
$xxxx.xx
% decrease of
% increase of
% xxx
Xx tons

### xx Containers

### xx Pallets

xxx people
xxx units
project aaa
program bbb

At 360, assessment module 220 automatically determines the number of performance objectives without a time measure. The “time measure” term refers to whether the objective imposes a timeframe during which the desired result is to be achieved.

As part of 360, assessment module 220 passes each objective to parsing module 250. Parsing module 250 parses each objective for time measures, based on data retrieved from parsing lexicon 280, and then automatically returns a result to assessment module 220 indicating whether or not the given objective meets the criteria. Assessment module 220 keeps a tally of the number of objectives without time measures, and may pass the number to data handling module 230 to be stored in data storage 140. Some examples of terms that may indicate that the time criteria is being met, being terms that may be stored in parsing lexicon 280 and terms that parsing module 240 may parse for, may include but are not limited to:

‘by “April” 200x’

### by August 200x by

### December 200x

### by EOFY 200x

### by EOQ1

### by EOQ2

### by EOQ3

### by EOQ4

### by EOY 200x

### by February 200x

### by January 200x

### by July 200x

### by June 200x

### by March 200x

### by May 200x

### by November 200x

### by October 200x

### by September 200x

At 370, assessment module 220 automatically determines a number of employee objectives without a quality measure. The “quality measure” term refers to whether the objective imposes a constraint on how the result may be achieved while maintaining the integrity of the intent of the goal. For example, the objective may include constraints such as maintaining a high level of customer/client satisfaction or keeping within a set financial budget. Meeting the quality criteria may mean that objectives are reasonable, and prevents employees from applying potentially limitless amounts of money or people or resources to achieving a goal. The quality criteria may be met by reference to the retention of customers, an improvement in customer appreciation of the business, or the morale of the staff.

As part of 370, assessment module 220 may pass each objective to parsing module 250. Parsing module 250 parses each objective for quality measures, based on data retrieved from parsing lexicon 280, and then automatically returns a result to assessment module 220 indicating whether or not the given objective meets the criteria. Assessment module 220 keeps a tally of the number of objectives without quality measures, and may pass the number to data handling module 230 to be stored in data storage 140. Some examples of terms that may indicate that the quality criteria is being met, being terms that may be stored in parsing lexicon 280 and terms that parsing module 240 may parse for, may include but are not limited to:

### to “AS” 4037 ‘Standard’

### to AS 14000′

to P&P standards
while maintaining xxx
within current xxx limits

At 380, assessment module 220 may, in some embodiments, automatically receive configuration settings 290 from configuration settings module 240. Alternatively, the method may move directly to step 390.

Configuration settings 290 received may include calibration settings that indicate the results for each of the assessment criteria that are considered to be poor, permissible, or good. Assessment module 220 may apply configuration settings 290 to each of the results stored in data storage 140 during the assessment process. For example, assessment module 220 may apply configuration settings 290 to the total number of objectives, the number of short objectives, the number of objectives that do not contain a hard verb, the number of objectives that do not contain a quantity measure, the number of objectives that do not contain a time measure, and the number of objectives that do not contain a quality measure. In some embodiments, configuration settings 290 may indicate that having less than five objectives is poor, between five and ten objectives is permissible and over 10 objectives is good, for example.

Assessment module 220 may calculate a weighted total result or score based on the results for each assessment criteria 270. Some criteria may be deemed to be less important than others, and so given a lesser weight. For example, it may be decided that having a time measure is not as important as the other assessment criteria, and so a score for the number of objectives that have a time measure may be reduced by 20%, in some cases.

At 390, assessment module 220 automatically determines an assessment result, which in some embodiments may be in the form of a score. In some embodiments, assessment module 220 outputs a total weighted result or score for the employee and/or the individual calibrated results or scores to a component of user interface 160, such as output screen 165, through user interface module 210. The results or scores may be displayed as a percentage, a numerical score, a descriptive score and/or a graphic score. For example, in some embodiments the scores may be displayed as a combination of a percentage, a descriptive score and a graphical representation of the score. The descriptive score may range from “Needs improvement” for a score of between 0% and 50%, to “Adequate” for a score of between 50% and 75%, through to “Excellent” for a score of between 75% and 100%. The bar may be coloured red between 0% and 50%, orange between 50% and 75%, and green between 75% and 100%, for example.

The exact scores correlating to each description and colour may be stored in data storage 140 and retrieved for processing by configuration settings module 240. All of the scores may also be stored in data storage 140.

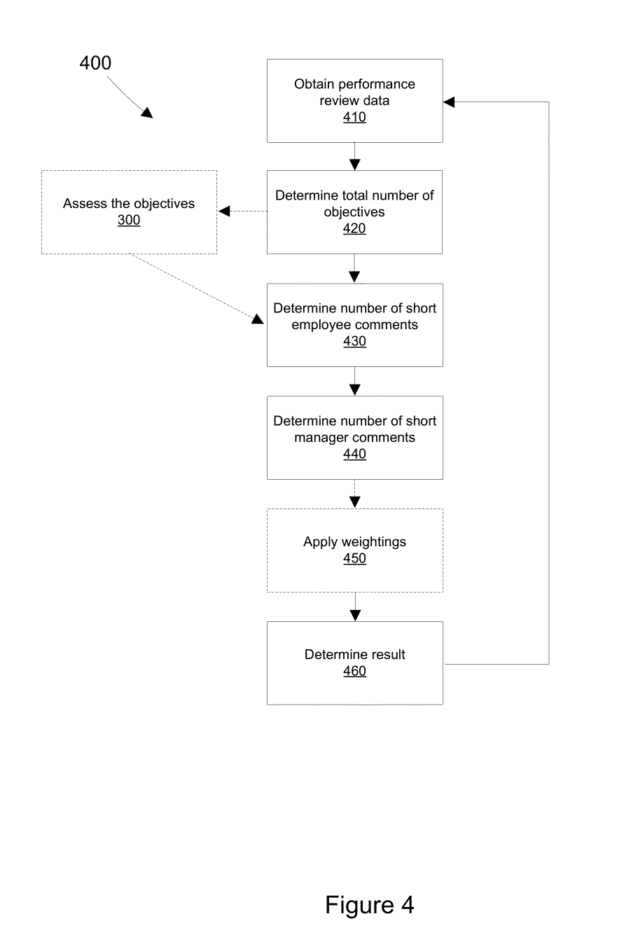

FIG. 4 shows a computer implemented method 400 which may be implemented by application 200 when executed by processor in order to assess an employee's performance review report based on assessment criteria 270. In the illustrated embodiment, assessment criteria 270 include a total number of objectives, a number of short employee comments, and a number of short manager comments.

At step 410, assessment module 220 obtains a performance review report associated with an employee. The performance review report may be retrieved from an employee record 260 stored in data storage 140 or an external data storage means by data handling module 230, or may be retrieved directly through user interface module 210, in some embodiments.

The performance review report may include data from one or more reviews, which may include mid-year and end of year performance reviews, for example. The performance review report may include objectives and/or comments made by the employee and/or their manager.

At 420, assessment module 220 automatically determines a total number of performance review objectives entered by the employee. Assessment module 220 may pass the total number of performance review objectives to data handling module 230 to be stored in data storage 140. Optionally, performance review objectives may be then be assessed following method 300. Alternatively, method 400 progresses to step 430.

At 430, assessment module 220 automatically determines a total number of short employee comments entered by the employee. For example, an employee comment may be determined to be a short employee comment if it does not meet a length requirement in either characters, words, or both. Assessment module 220 may pass the total number of short employee comments to data handling module 230 to be stored in data storage 140.

At 440, assessment module 220 automatically determines a total number of short manager comments entered by the employee's manager. For example, a manager comment may be determined to be a short manager comment if it does not meet a length requirement in either characters, words, or both. Assessment module 220 may pass the total number of short manager comments to data handling module 230 to be stored in data storage 140.

At 450, assessment module 220 optionally retrieves configuration settings 290 from configuration settings module 240. Alternatively, the method progresses to step 460.

Configuration settings 290 received may include calibration settings that indicate scores for each of the assessment criteria that are considered to be poor, permissible, or good. Assessment module 220 may apply configuration settings 290 to each of the results stored in data storage 140 during the scoring process. For example, assessment module 220 may apply configuration settings 290 to the total number of performance review objectives, the number of short employee comments, and the number of short manager comments. In some embodiments, configuration settings 290 may indicate that having less than five performance review objectives is poor, between five and ten performance review objectives is permissible and over 10 performance review objectives is good, for example.

Assessment module 220 may also calculate a weighted total result or score based on the results or scores for each assessment criteria. Some criteria may be deemed to be less important than others, and so given a lesser weight in the configuration settings 290. For example, it may be decided that having manager comments is not as important as the other assessment criteria, and so a score for the number of manager comments may be reduced by 20%, in some cases.

At 460, assessment module 220 automatically determines an assessment result, which in some embodiments may be in the form of a score. In some embodiments, assessment module 220 outputs a total weighted result or score for the performance review report and the individual calibrated results or scores to a component of user interface 160, such as output screen 165, through user interface module 210. The results or scores may be displayed as a percentage, a numerical score, a descriptive score and/or a graphic score. For example, in some embodiments the results or scores may be displayed as a combination of a percentage, a descriptive score and a graphical representation of the score. The descriptive score may range from “Needs improvement” for a score of between 0% and 50%, to “Adequate” for a score of between 50% and 75%, through to “Excellent” for a score of between 75% and 100%. The bar may be coloured red between 0% and 50%, orange between 50% and 75%, and green between 75% and 100%, for example.

The exact scores correlating to each description and colour may be stored by the user in data storage 140 and retrieved for processing by configuration settings module 240. All of the scores may also be stored in data storage 140.

In some embodiments, assessment application 200 may automatically monitor and assess a quantity of meetings associated with the employee, such as meetings held between the employee and their managers, for example.

Meeting data regarding meetings associated with the employee which have been held or are scheduled to be held may be stored in the employee record 160. For example, the meeting data may be received by user interface module 210 and stored in data storage 140.

In some embodiments, assessment module 220 may receive commands from user interface module 210 to initiate an automatic assessment of the meeting data.

Assessment module 220 retrieves meeting data associated with an employee. The meeting data may be retrieved from an employee record 260 stored in data storage 140 or an external data storage means by data handling module 230, or may be retrieved directly through user interface module 210, in some embodiments.

Assessment module 220 may provide the meeting data to parsing module 240, which may parse the data for the dates the entries were made. Assessment module 220 may automatically determine a meeting result which may comprise a total number of meetings held and/or a total number of meetings scheduled and/or a total number of meeting cancelled and may pass the meeting result to data handling module 230 to be stored in data storage 140

Assessment module 220 may then output the determined meeting result or score to user interface module 210 for display on an output 160. The results or scores may be displayed as a percentage, a numerical score, a descriptive score and/or a graphic score. For example, in some embodiments the results or scores may be displayed as a combination of a percentage, a descriptive score and a graphical representation of the score. The descriptive score may range from “Needs improvement”, to “Adequate”, through to “Excellent”. The bar may be coloured red, orange, and green to reflect the various scores, for example. The colour coding and descriptive scores may be calibrated by the user to reflect the standards at each particular workplace. For example, in some cases, one meeting per half year may be scored as “Needs improvement”, two meetings per half year may be “Adequate”, and more than two meetings every half year may be “Excellent”.

Assessment application 200 may use the results from the assessment of the performance records such as the objectives report, performance review report, and meeting data report, to automatically determine an overall result for the performance monitoring activities associated with an employee record 260, which may be a score-based result in some embodiments. In some embodiments, assessment module 220 may use configuration settings 290 received from configuration settings module 250 to apply weightings to the objectives score, performance reviews score and meetings score, in order to formulate an overall reported score for each performance record and/or the employee and/or manager.

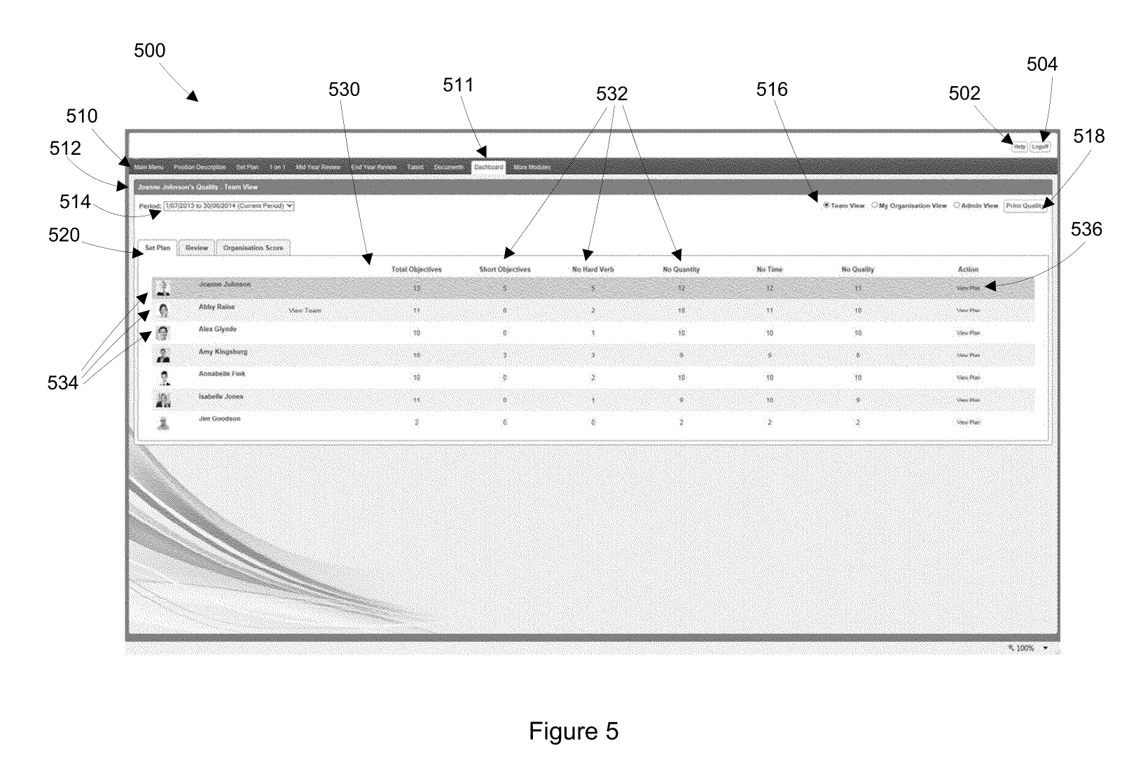

FIG. 5 shows an example display 500 that may be presented on output screen 165 of computing device 100 by assessment application 200. Display 500 has a “Help” button 502 and a “Logoff” button 504, which may be configured to cause processor 150 to display help instructions for using assessment application 200, and to change which user profile is logged in or to shut down the program.

Display 500 has a tab index 510 with a number of labelled tabs corresponding to features of assessment application 200. These tabs may include “Main Menu”, through which a user may be able to log in; “Position Description”, which may provide a description of the role of a selected or logged in employee; “Set Plan”, through which an employee may be able to enter set objectives; “1 on 1”, through which one-to-one meetings between employees and managers may be organised; “Mid Year Review”, through which an employee and their manager may be able to enter objectives and comments for their mid-year review; “End Year Review”, through which an employee and their manager may be able to enter objectives and comments for their end of year review; “Talent” through which an employee and their manager may be able to enter qualities or specific talents associated with the employee; “Documents”, through which a user may be able to upload and download relevant documents; “Dashboard” through which the user may be able to monitor the assessed objectives and performance reviews; and “More Modules”, through which the user may be able to access additional features. In the illustrated screenshot, “Dashboard” tab 511 is selected.

Dashboard tab 511 has a label 512 showing the name of the employee who is logged in, and what view is enabled. The view can be changed by selecting the radio buttons 516. In the illustrated example, “Team View” is selected. Alternative views might be available, such as “My Organisation View” and “Admin View”, for example. “My Organisation View” may provide a consolidated view of the information displayed by the “Team View”, or a consolidated view of multiple “Team View” views, and the “Admin View” may provide a customised view of details pertaining only to the administration of the display 500. A user may be able to adjust the printer settings through “Print Quality” button 518. Dashboard tab 511 also includes a period selection box 514 to allow the user to select the time period that they wish to see data for.

Dashboard tab includes a secondary tab index 520, which may contain tabs allowing the user to navigate through various assessment data sets. Tab index 520 includes a “Set Plan” tab, allowing a user to look at data for set objectives; a “Review” tab, allowing the user to look at data for performance reviews, and an “Organisation Score” tab, allowing the user to see an overall score for each employee. In the display illustrated in FIG. 5, the “Set Plan” tab is selected.

Selecting the “Set Plan” tab displays objective assessment table 530. Table 530 has columns rows 534 and columns 532 showing data retrieved from employee records 260. Rows 534 each correspond to employees with saved employee records 260. Assessment application 200 may be configured to only display a selection of employee data in table 530, depending on the privileges of the logged in user. For example, a logged in user that is a manager may have permission to view data for all of the employees in their team. Some employees may only be able to access their own data.

Columns 532 correspond to assessment criteria 270 by which employee's set objectives are assessed. For example, the columns may include “Total Objectives”, showing the total number of objectives determined for an employee by processor 150 at step 320 of method 300; “Short Objectives”, showing the number of short objectives determined for an employee by processor 150 at step 330 of method 300; “No Hard Verb”, showing the number of objectives determined to not have a hard verb as assessed by processor 150 at step 340 of method 300; “No Quantity”, showing the number of objectives determined to not have a quantity measure as assessed by processor 150 at step 350 of method 300; “No Time”, showing the number of objectives determined to not have a time measure as assessed by processor 150 at step 360 of method 300; and “No Quality”, showing the number of objectives determined to not have a quality measure as assessed by processor 150 at step 370 of method 300. Table 530 may further have an “Action” column, having “View Plan” button 536 which allows for the user to view the objectives made by the selected employee and to keep track of their progress.

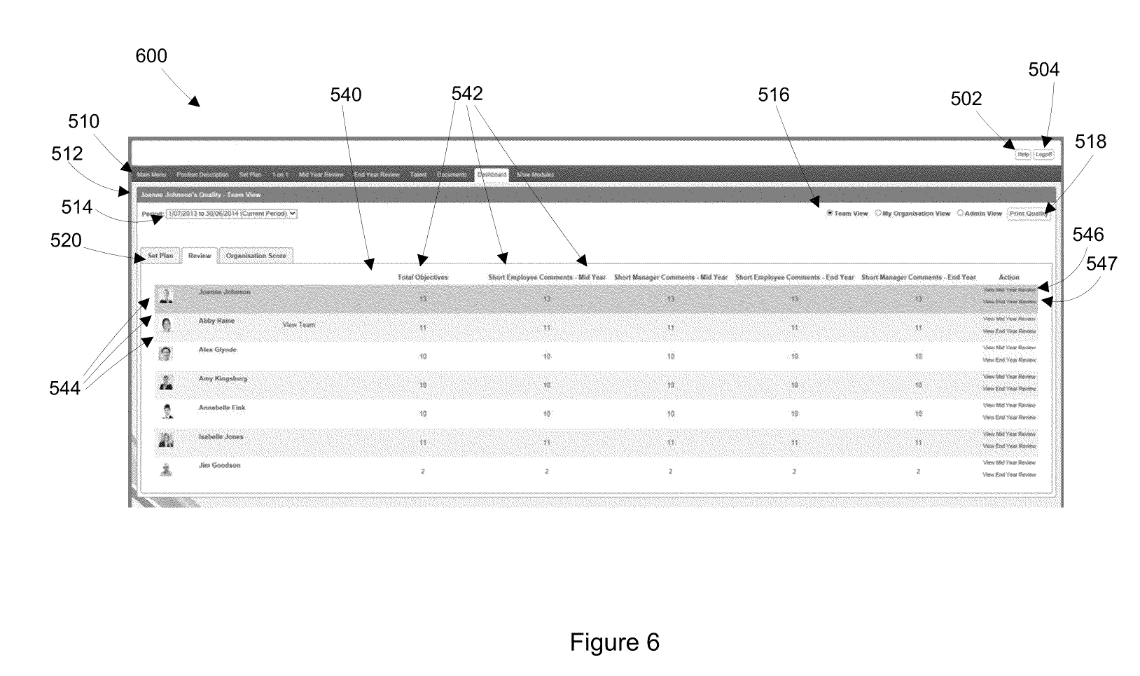

FIG. 6 shows an example display 600 that may be presented on screen 165 of computing device 100 by assessment application 200. Display 600 has “Help” button 502, “Logoff” button 504, and tab index 510, as described above with reference to display 500. Also as in display 500, “Dashboard” tab 511 is selected, displaying label 512, radio buttons 516, “Print Quality” button 518 period selection box 514, and secondary tab index 520. In the display illustrated in FIG. 6, the “Review” tab is selected.

Selecting the “Review” tab displays performance review assessment table 540. Table 540 has columns rows 544 and columns 542 showing data retrieved from employee records 260. Rows 544 each correspond to employees with saved employee records 260. Assessment application 200 may be configured to only display a selection of employee data in table 540, depending on the privileges of the logged in user. For example, a logged in user that is a manager may have permission to view data for all of the employees in their team. Some employees may only be able to access their own data.

Columns 542 correspond to assessment criteria 270 by which employee's performance reviews are assessed. For example, the columns may include “Total Objectives”, showing the total number of objectives determined for an employee by processor 150 at step 420 of method 400; “Short Employee Comments—Mid Year”, showing the number of short comments made at a mid-year review by the employee, as determined by processor 150 at step 430 of method 400; “Short Manager Comments—Mid Year”, showing the number of short comments made at a mid-year review by the manager, as determined by processor 150 at step 440 of method 400; “Short Employee Comments—End Year”, showing the number of short comments made at an end of year review by the employee, as determined by processor 150 at step 430 of method 400; and “Short Manager Comments—End Year”, showing the number of short comments made at an end of year review by the manager, as determined by processor 150 at step 440 of method 400. Table 540 may further have an “Action” column, having “View Mid Year Review” button 546 and “View End Year Review” button 547, which allows for the user to view the performance reviews of the employee and to keep track of their progress.

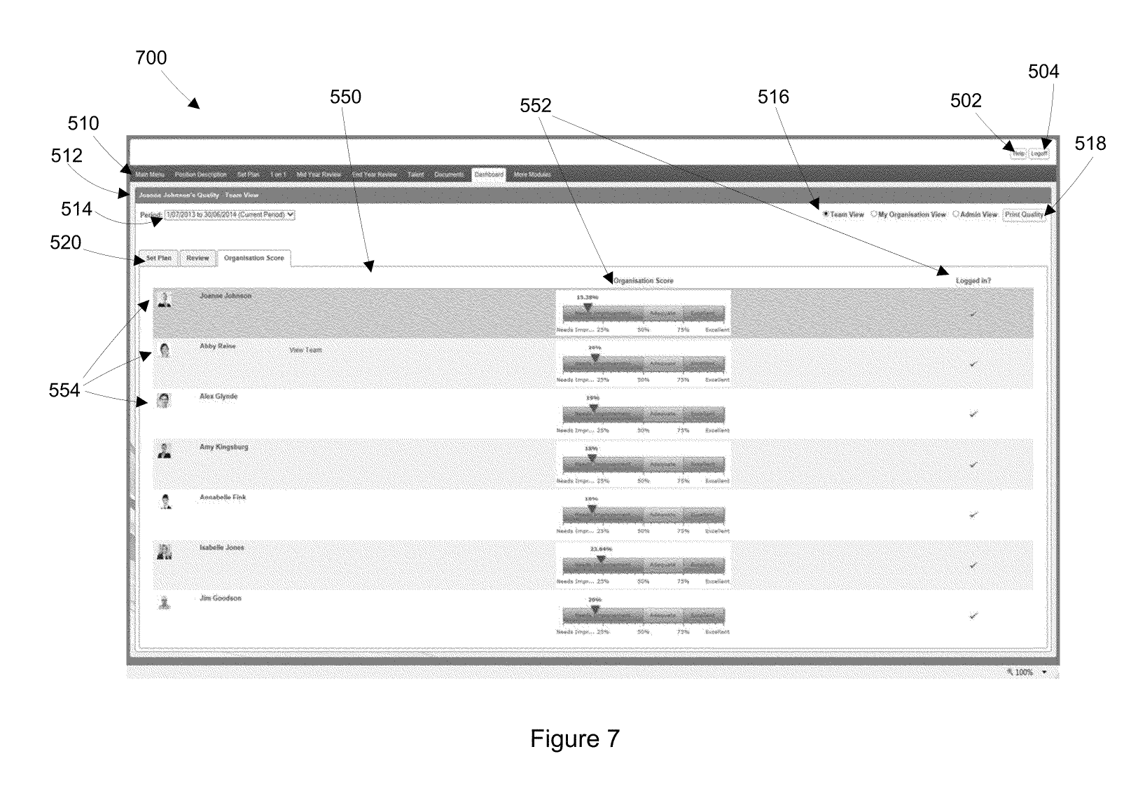

FIG. 7 shows an example display 700 that may be presented on screen 165 of computing device 100 by assessment application 200. Display 700 has “Help” button 502, “Logoff” button 504, and tab index 510, as described above with reference to display 500. Also as in display 500, “Dashboard” tab 511 is selected, displaying label 512, radio buttons 516, “Print Quality” button 518 period selection box 514, and secondary tab index 520. In the display illustrated in FIG. 7, the “Organisation Score” tab is selected.

Selecting the “Organisation Score” tab displays organisation score table 550. Table 550 has columns rows 554 and columns 552 showing data retrieved from employee records 260. Rows 554 each correspond to employees with saved employee records 260. Assessment application 200 may be configured to only display a selection of employee data in table 540, depending on the privileges of the logged in user. For example, a logged in user that is a manager may have permission to view data for all of the employees in their team. Some employees may only be able to access their own data.

Columns 552 include an “Organisational Score” column, which displays an overall score for each employee. The scores are displayed as a combination of a percentage, a descriptive score and a graphical representation of the score. In the illustrated embodiment, the descriptive score ranges from “Needs improvement” for a score of between 0% and 50%, to “Adequate” for a score of between 50% and 75%, through to “Excellent” for a score of between 75% and 100%. The graphical representation is shown as a bar that is coloured red between 0% and 50%, orange between 50% and 75%, and green between 75% and 100%. Columns 552 also include a “Logged In” column that displays a tick if the corresponding employee is logged in to assessment application 200.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for automatic assessment of performance monitoring activities, the system comprising:
an interface for receiving commands to perform the automatic assessment of performance monitoring activities;
memory comprising an executable assessment application; and
at least one processor configured to access and execute the assessment application to automatically assess performance monitoring activities in response to receiving a command from the interface, the assessment application comprising:
an assessment module for obtaining a performance record associated with an employee, wherein the performance record comprises at least one performance objective; and
a parsing module for parsing the performance report to determine whether each objective includes assessment criteria, wherein the assessment criteria comprises a hard verb, a quantity measure, a time measure and a quality measure and for determining a first parsed result, the first parsed result being based on the determination of whether each objective includes assessment criteria;
wherein the assessment module is configured to determine a first assessment result based on the first parsed result.

2. The system of claim 1, wherein the interface is a user interface and the user interface is configured to receive the command to automatically assess performance monitoring activities from a user.

3. The system of claim 2, wherein the assessment module is configured to provide the assessment result to the user interface for outputting to the user.

4. The system of claim 1, further comprising a communications interface to facilitate wired or wireless communications and wherein the assessment module is configured to provide the assessment result to the communications interface for transmitting to a computing device or database.

5. The system of claim 1, wherein the interface is a communications interface to facilitate wired or wireless communications and is configured to receive the command to automatically assess performance monitoring activities from a remote computing device.

6. The system of claim 5, wherein the assessment module is configured to provide the assessment result to the communications interface for transmitting to a computing device or database.

7. The system of claim 5, further comprising a user interface and the assessment module is configured to provide the assessment result to the user interface for outputting to a user.

8. The system of claim 1, further comprising data storage for storing data pertaining to the assessment application.

9. The system of claim 8, wherein the assessment module is configured to obtain the performance record and/or the assessment criteria from the data storage.

10. The system of claim 1, wherein the assessment module is configured to obtain the performance record and/or the assessment criteria from remote data storage using the communications interface.

11. The system of claim 1, wherein the at least one performance record comprises at least one of a performance objective report, a performance review report and meeting data.

12. The system of claim 1, wherein the hard verb is associated with an active change which is proposed to be achieved, the quantity measure is a proposed level of increase or decrease of active change, the time measure is a time frame during which the active change is proposed to be achieved and the quality measure is a constraint applied in order to achieve the active change.

13. The system of claim 1, wherein the assessment module is configured to access a parsing lexicon comprising a list of terms associated with each assessment criterion and the parsing module is configured to parse the performance record by comparing the performance record with the terms of the parsing lexicon to determine whether the performance record includes at least one of the terms.

14. The system of claim 1, wherein the first parsed result comprises an indication of a number of performance objectives which include each of the assessment criteria.

15. The system of claim 1, wherein the assessment module is further configured to determine a total number of objectives in the performance record and wherein the assessment result also depends on the total number of objectives in the performance record.

16. The system of claim 1, wherein the assessment module is further configured to determine a total number of short objectives in the performance record and wherein the assessment result also depends on the number of short objectives in the performance record.

17. The system of claim 1, wherein the performance report further comprises a performance review record and wherein the parsing module is configured to parse the performance record to determine a second parsed result based on at least one of a number of employee comments associated with an employee and a number of comments associated with a manger of the employee and the assessment module is configured to determine a second assessment result based on the second parsed result.

18. The system of claim 17, wherein the assessment module is configured to determine an overall assessment result based on the first and second assessment results.

19. The system of claim 1, wherein the performance report further comprises a meeting data record and wherein the parsing module is configured to parse the performance record to determine a third parsed result based on an occurrence of meetings between an employee and their manager and the assessment module is configured to determine a third assessment result based on the third parsed result.

20. The system of claim 19, wherein the assessment module is configured to determine an overall assessment result based on at least one of the first, second and third assessment results.

21. The system of claim 1, wherein the assessment module is configured to obtain configuration settings and to apply the configuration settings to the assessment result to determine a weighted assessment result.

22. A system for automatic assessment of performance monitoring activities, the system comprising:
an interface for receiving commands to perform the automatic assessment of performance monitoring activities;
memory comprising an executable assessment application; and
at least one processor configured to access and execute the assessment application to automatically assess performance monitoring activities in response to receiving a command from the interface, the assessment application comprising:
an assessment module for obtaining a performance record associated with an employee, wherein the performance record comprises at least one performance review report; and
a parsing module for parsing the performance report to determine a parsed result based on at least one of a number of employee comments associated with an employee and a number of comments associated with a manger of the employee; and
wherein the assessment module is configured to determine an assessment result based on the first parsed result.

23. The system of claim 22, wherein the performance report further comprises a meeting data record and wherein the parsing module is configured to parse the performance record to determine a second parsed result based on an occurrence of meetings between an employee and their manager and the assessment module is configured to determine a second assessment result based on the second parsed result.

24. The system of claim 23, wherein the assessment module is configured to determine an overall assessment result based on at least one of the first and second assessment results.

25. A computer implemented method of assessing performance monitoring activities, the method operable in a computing system comprising an interface for receiving commands to perform the automatic assessment of performance monitoring activities, memory comprising an executable assessment application and at least one processor configured to access and execute the assessment application to automatically assess performance monitoring activities in response to receiving a command from the interface, the method comprising:
obtaining by an assessment module of the assessment application a performance record associated with an employee, wherein the performance record comprises at least one performance objective;
parsing by a parsing module of the assessment application, the performance report to determine whether each objective includes assessment criteria, wherein the assessment criteria comprises a hard verb, a quantity measure, a time measure and a quality measure;
determining by a parsing module a parsed result, the parsed result being based on the determination of whether each objective includes assessment criteria; and
determining by the assessment module a first assessment result based on the parsed result.

26. The method of claim 25, wherein the method further comprises determining at least one of a total number of objectives in the performance record and a number of short objectives in the performance record, and wherein the first assessment result is further based on at least one of the total number of objectives and number of short objectives.

27. The method of claim 25, wherein the performance report further comprises a performance review record and further comprising parsing by the parsing module the performance record to determine a second parsed result based on at least one of a number of employee comments associated with an employee and a number of comments associated with a manger of the employee and determining by the assessment module a second assessment result based on the second parsed result.

28. The method of claim 27, further comprising determining an overall assessment result based on at least one of the first and second assessment results.

29. The method of claim 25, wherein the performance report further comprises a meeting data record and further comprising parsing by the parsing module the performance record to determine a third parsed result based on an occurrence of meetings between an employee and their manager and determining by the assessment module a third assessment result based on the third parsed result.

30. A computer program product comprising a non-transitory computer readable medium encoded with computer executable instructions, which when executed in a computer system, is effective to cause the computer system to carry out the steps of the method of claim claim 25.
